(19) United States
(12) Patent Application Publication
(10) Pub. No.: US 2006/0043730 A1
(43) Pub. Date: Mar. 2, 2006

(54) Book that can change color & applicator

(76) Inventor: Michael Bianco, Westlake Village, CA (US)

Correspondence Address: Law Office of Richard B. Klar;Suite 2301, 875 Avenue of the Americas, New York, NY, 10001, US

(21) Appl. No.: 11/211,047

(22) Filed: Aug. 24, 2005

Related U.S. Application Data
(60) Provisional application No. 60/604,282, filed on Aug. 25, 2004.

(51) Int. Cl. B42D 15/00

(52) U.S. Cl. 283/117

(57) ABSTRACT

A book that is capable of portions of the book change color when fluid containing water is applied to these portions by an applicator containing the fluid.

This is a non-provisional application of a provisional application Ser. No. 60/604,282 by Michael Bianco filed Aug. 24, 2004.

### BACKGROUND OF THE INVENTION

1. Field of the Invention

The present invention relates to a book such as a storybook having portions adapted to change color. In particular the book can have characters or scenery that when fluid containing at least some water is applied to it by an applicator changes color.

2. The Prior Art

Map's 1-2-3 Art set sold by JAKKS Pacific, inc. permits painting by just adding water.

This item does not teach nor suggest the use of a color changing story book for a child to color within a coloring story book by using water.

This is less messy than conventional coloring or painting books including notebooks, pads, etc.

### SUMMARY OF THE INVENTION

The present invention provides a book that is capable of having a portion of its pages change color when fluid containing at least some water is applied to these portions by an applicator containing the fluid which contains at least some water. In particular the book preferably is made of general card paper material on which is printed preferably four colors. It is then coated with a protective oil and then silk screened with hydro water developer ink as a top layer. The hydro water developer ink provides for a translucent white material cover that hides the colors underneath. When fluid containing water is applied to the layer of hydro water developer ink the colors are revealed until the water dries up on the hydro water developer ink layer.

### BRIEF DESCRIPTION OF THE DRAWINGS

FIG. 1 is a book page (etc.) in dry condition (e.g., before it was wetted or after it was dried.

FIG. 2 is process of wetting using water dispenser.

FIG. 3 is the same page when colors were developed.

FIG. 4 shows the lower layer (card paper with printed color ink with black velvet borders around).

FIG. 5 shows the top (upper) layer—translucent hydra water developer having some spots covered with waterproof material. These spots remain white when page is wetted.

### DETAILED DESCRIPTION OF THE PREFERRED EMBODIMENT

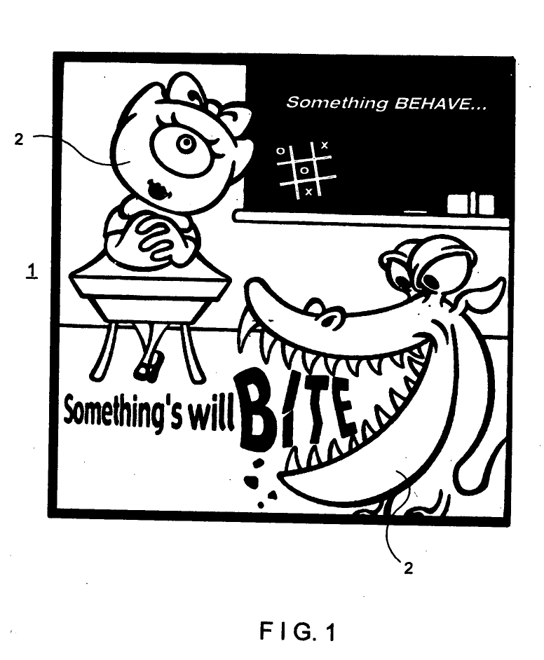

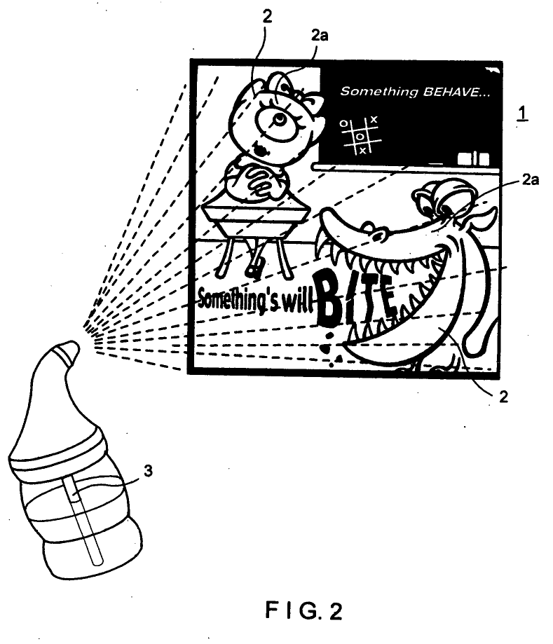

Referring now to the drawings, FIG. 1 illustrates a book 1 that has portions 2 that are susceptible to changing color when fluid containing water is applied to these portions. (See FIG. 2) The fluid can either contain all water or some water in dispenser such as a water based marker. Alternatively a paint brush or any other water dispensing applicator 3 can be used.

The advantage is that by using a harmless ingredient such as water children can color their books. The water can be applied by an applicator such as a plastic water bottle and nozzle dispenser to squirt water on the portions 2 of the book 1. In addition a marker (not shown) from which fluid containing at least some water can be ejected onto the pages of the book 1 can also be used or else a paintbrush. Colors are pre-printed on the page of the book 1 in the portions 2. The colors used are based on a known four color printing process utilizing black cyan—a type of blue, yellow, and magenta colors to derive whatever colors are desired for the particular design. They are then covered by the white areas 2a.

The book 1 can be of general card paper, preferably general coated paper or coated board, on which colors are preferably printed thereon. It is then coated with a protective oil. The upper layer of white area is made of hydro water developer ink and is silk screened on.

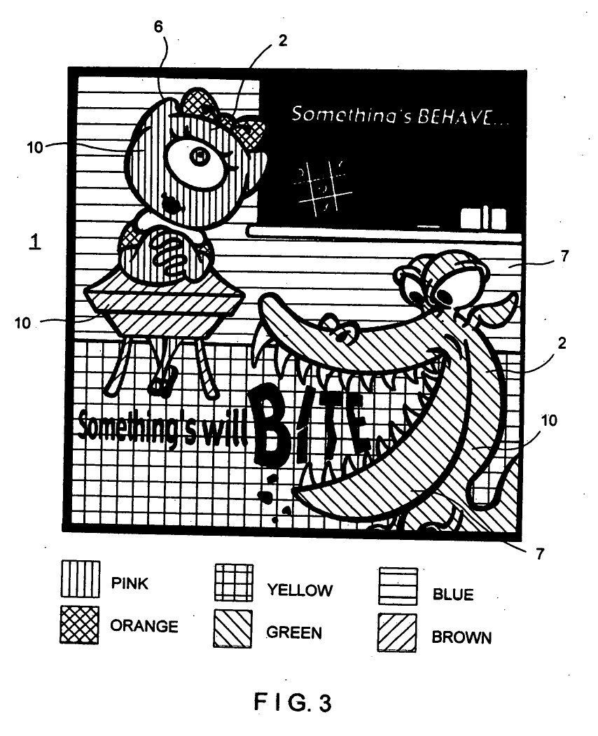

The book 1 can have characters 6 or scenes 7 that are colored and covered by the white areas 2a or portions 2 which is the translucent layer of hydro water developer ink. The hydro water developer ink is roughly 6 grams per 160 square inches of paper area. The ink thickness may vary some based on the artwork design. If a certain area 2 needs water ink on it this area will become thicker. The hydro water developer ink contains mainly water, silicon dioxide and hydro polyurethane resin. The hydro water developer ink is silk screened on the general card paper as a top layer. When water is applied to these layers these white areas turn clear enough so that the colors underneath that are pre-printed on the page can be seen so that a user such as a child is effectively coloring in these areas by using the water. If a water based marker is used the water in the marker will make the colors printed underneath appear. In either case the underlying colors (See FIG. 3) will be come visible due to the water deposited on these white areas 2.

When the water dries, the white layer areas 2a becomes opaque again, and the child can color again by applying water on the white layer areas 2a. As seen in FIGS. 1-5, the invention works as follows.

FIG. 1 is a page of the book in dry condition before being wetted by the dispenser or applicator.

FIG. 2 shows the page of the book being wetted by a dispenser 3 or applicator 3.

FIG. 3 is the same page after it is wetted showing the pre-printed colors in the area 2 becoming visible as the white opaque layer area 2a covering the colors 10 is now clear.

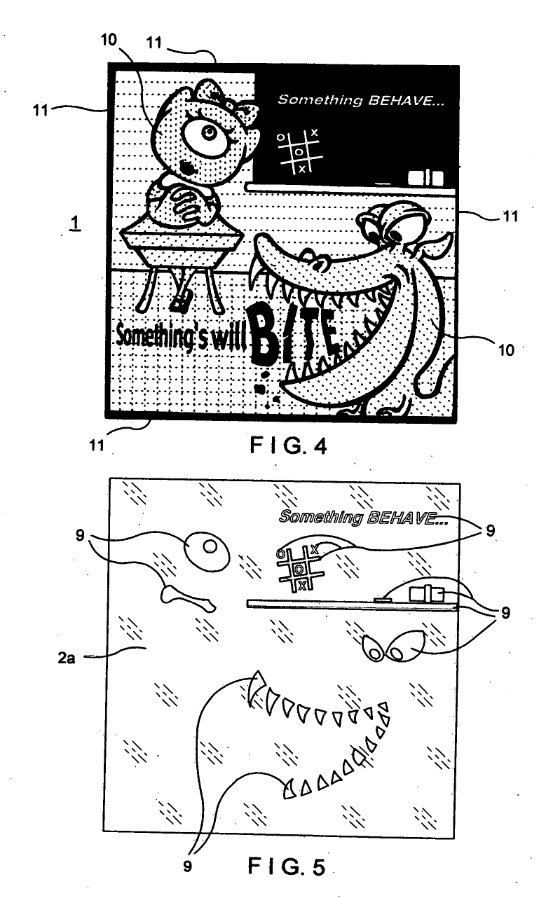

FIG. 4 illustrates the lower layer covered by the white area with the pre-printed colors 10 and the black borders 11 around it.

FIG. 5 shows the top layer 2a with water proof spots 9 that remain white when one page of the book 1 is wetted.

The result is a color changing story book that can be reused and is not messy since water is the ingredient for revealing the colors that are pre-printed in the areas 2 covered by the white layers 2a.

I do not limit myself to any particular details of construction set forth in the specification and illustrated in the accompanying drawings, as the same refers to and sets forth only certain embodiments of the invention, and it is observed that the same may be modified without departing from the spirit and scope of the claimed invention.

1. A book adapted to change colors, comprising:
portions of the book that are treated to change color when water is applied thereto; and
a dispenser containing fluid that includes water so that when the fluid is applied to the portions of the book said portions change color.

2. The book according to claim one wherein said portions of the book may include pages having colors there on in at least certain areas whereon said certain areas are covered by a hydro water developer ink so as to appear white and wherein said fluid is applied to said portions, said white areas clear up so that the colors located underneath are visible.

3. The book according to claim two wherein said water is applied to said white areas dries up, said white areas become opaque again and the colors in said areas are no longer visible.

4. The book according to claim one wherein said water can be applied by an applicator such as a plastic bottle with nozzle dispenser to squirt water onto these portions of said book.

5. The book according to claim one wherein said fluid is dispensed by a paintbrush.

6. The book according to claim one wherein said fluid is dispensed by a water marker wherein said fluid can be ejected onto certain areas of said book.
